(19) United States
(12) Patent Application Publication
(10) Pub. No.: US 2026/0158973 A1
(43) Pub. Date: Jun. 11, 2026

(54) RECLINING DEVICE AND SEAT

(71) Applicant: DELTA KOGYO CO., LTD., Hiroshima (JP)

(72) Inventor: Shogo MASUMURA, Hiroshima (JP)

(73) Assignee: DELTA KOGYO CO., LTD., Hiroshima (JP)

(21) Appl. No.: 19/126,642

(22) PCT Filed: Nov. 21, 2023
(86) PCT No.: PCT/JP2023/041897

§ 371 Date: May 1, 2025

(30) Foreign Application Priority Data
Dec. 21, 2022 (JP) 2022-204632

(51) Int. Cl. B60N 2/235

(52) U.S. Cl. CPC B60N 2/236

(57) ABSTRACT

A reclining mechanism includes: a guide bracket, an internal gear, a plurality of lock gears, a cam configured to rotate to radially move the lock gears, and a lock spring that urges the cam rotatably. The cam has a plurality of protrusions constituting a shaft part S inserted into a center hole of the guide bracket. Each of the protrusions has: a radially outer face constituting an outer circumferential surface being in contact with an inner circumferential surface defining the center hole of the guide bracket; and an engaged end. The cam is rotatably supported by the contact of the radially outer faces of the protrusions with the inner surface defining the center hole of the guide bracket and is rotatably urged by the lock spring engaging with the engaged end.

### TECHNICAL FIELD

The present invention relates to a reclining device, and a seat including the reclining device.

### BACKGROUND ART

Conventional seats for vehicles include a seat that comprises a reclining device to fixedly hold a seatback (backrest) at a certain tilt angle, the seatback being configured to be tiltable relative to a seat cushion (seat base) in a front-rear direction.

For instance, a reclining device described in Patent Literature 1 includes, as a main structure, a reclining mechanism 106 illustrated in FIG. 11 in a connection portion between a frame of a seat cushion and a frame of a seatback. The reclining mechanism 106 is arranged on each of the left and right sides of the seat. The reclining mechanism 106 includes: a guide bracket 120 to be fixedly attached to the frame of the seat cushion; an internal gear 130 to be fixedly attached to the frame of the seatback; a plurality of lock gears 60A to 60D (i.e., lock plates) each having an external tooth 63 configured to mesh with an internal tooth 132 of the internal gear 130; a cam 150 configured to radially move the lock gears 60A to 60D; and a lock spring 140. The lock gears 60A to 60D and the cam 150 are located between the guide bracket 120 and the internal gear 130.

The cam 150 has a main body portion 152 having a plurality of engagement projections 151 and a plurality of stepped portions 152b on an outer circumference of the main body portion 152. The main body portion 152 has a rod insertion hole 152a to which a connecting rod (not shown) is connected through a through hole 135 of the internal gear 130 for connection.

Each of the lock gears 60A to 60D is movable, in conjunction with the rotation of the cam 150, in a radial direction of the guide bracket 120 along guide walls (not shown) on a facing surface (inner surface) of the guide bracket 120 that faces the internal gear 130. Each of the lock gears 60A to 60D is further shiftable between a meshing position where the external tooth 63 of each lock gear meshes with the internal tooth 132 of the internal gear 130 and a release position to release the meshing. For instance, when the cam 150 rotates clockwise, four engagement projections 151 of the cam 150 respectively engage with the grooves to be engaged 61 of the lock gears 60A to 60D to pull the lock gears 60A to 60D toward the center of the cam 150 and move each of the lock gears from the meshing position to the release position. By contrast, when the cam 150 is urged by the lock spring 140 and rotates counterclockwise or anticlockwise, the engagement projections 151 and the stepped portions 152b of the cam 150 push the lock gears 60A to 60D radially outward from the cam 150 to move each lock gear from the release position to the meshing position.

The lock spring 140 urges the cam 150 rotatably in such a direction as to shift each of the lock gears 60A to 60D from the release position to the meshing position. The lock spring 140 is a spiral spring, and is located in a hole 122 of the guide bracket 120. The lock spring 140 is assembled with an inner end 142 thereof engaging with an engagement groove 153a of a first shaft portion 153 of the cam 150 and an outer end 141 thereof engaging with an engagement groove 122a of the guide bracket 120.

The internal gear 130 has, at the center thereof, a second shaft portion 136 protruding in an axial direction of the internal gear 130. The cam 150 has, at the center thereof, a recess 154 (see FIG. 12) that receives the second shaft portion 136 fitting therein. Such fitting of the second shaft portion 136 of the internal gear 130 in the recess 154 of the cam 150 allows the cam 150 to be coaxially assemble to the internal gear 130. The lock gears 60A to 60D are attached to the guide walls (not shown) while being in contact with the surface (facing surface) of the guide bracket 120 that faces the internal gear 130. In this manner, the guide bracket 120 determines respective positions of the lock gears 60A to 60D.

The guide bracket 120 and the internal gear 130 are fixedly held by the attachment ring 170 while coaxially overlapping as illustrated in FIG. 13A and FIG. 13B. Specifically, the guide bracket 120 and the internal gear 130 are retained by an attachment ring 170 at such positions that the guide bracket 120 faces a concave portion 131 of the internal gear 130 and that an end surface 133a of a flange 133 surrounding the concave portion 131 faces a surface of the guide bracket 120. This prevents axial displacement between the lock gears 60A to 60D and the cam 150, that is, prevents the normal of a plane defined by the lock gears 60A to 60D being displaced from a rotation axis of the cam 150.

In the structure described in Patent Literature 1, the positions of the lock gears 60A to 60D depend on the position of the guide bracket 120, and the position of the cam 150 depends on the position of the internal gear 130. In this respect, when the guide bracket 120 and the internal gear 130 are displaced relative to each other due to manufacturing tolerance or other factor, the relative positions of the lock gears 60A to 60D and the cam 150 change. This may result in deviation of locking timing among the lock gears 60A to 60D.

Besides, in the structure, the cam 150 has such a configuration that the first shaft portion 153 of the cam 150 (to which the inner end 142 of the lock spring 140 is attached) and the recess 154 (in which the second shaft portion 136 of the internal gear 130 fits) align in an axial direction of the cam 150. The structure thus faces difficulty in reducing the size of the cam 150, particularly reducing the axial dimension (thickness) of the cam 150.

### CITATION LIST

### Patent Literature

Patent Literature 1: Japanese Unexamined Patent Publication No. 2020-168141

### SUMMARY OF INVENTION

The present invention has been accomplished in view of the circumstances described above, and has an object of providing a reclining device that prevents deviation of locking timing between or among a plurality of lock gears and achieves a size reduction in a cam.

A reclining device according to the present invention includes: a guide bracket that is a plate member having a center hole in a circular shape, the guide bracket being configured to be fixedly attached to one of a frame of a seat cushion and a frame of a seatback; an internal gear configured to be fixedly attached to the other of the frame of the seat cushion and the frame of the seatback in such a manner as to be rotatable relative to the guide bracket; a plurality of lock gears each having an external tooth configured to mesh with an internal tooth of the internal gear, each arranged in such a manner as to be movable along the guide bracket in a radial direction of the guide bracket, and each being shiftable between a meshing position where the external tooth and the internal tooth mesh and a release position where the meshing is released; a cam that is rotatable relative to the guide bracket, and configured to radially move each of the lock gears between the meshing position and the release position; and at least one lock spring that urges the cam rotatably in such a direction as to shift the lock gear from the release position to the meshing position. The guide bracket has a plurality of guide parts located away from each other in a circumferential direction around the center hole to respectively radially guide the lock gears. The cam has a shaft part located in the center hole of the guide bracket. The shaft part has an outer circumferential surface being in contact with an inner circumferential surface defining the center hole and an engaged section for engagement with the lock spring. The cam is rotatably supported relative to the guide bracket by the contact of the outer circumferential surface of the shaft part with the inner circumferential surface defining the center hole, and is rotatably urged by the lock spring by the engagement of the lock spring with the engaged section.

In the configuration, the cam has the shaft part located in the center hole of the guide bracket. The shaft part has the outer circumferential surface being in contact with the inner circumferential surface defining the center hole of the guide bracket, and the engaged section for engagement with the lock spring. The cam is rotatably supported relative to the guide bracket by the contact of the outer circumferential surface of the shaft part with the inner circumferential surface defining the center hole of the guide bracket.

The guide bracket guides the lock gears radially by the guide walls along the guide bracket, and axially aligns the inner circumferential surface defining the center hole and the shaft part of the cam. In other words, the position of the cam and the position of each of the lock gears can be determined on the basis of the guide bracket as a reference. This configuration achieves the same locking timing between or among the lock gears to be operated by the cam without axial displacement between the guide bracket and the cam regardless of possible manufacturing tolerance in the components including the guide bracket and the cam.

The shaft part of the cam fulfills the following two functions: axial alignment with the cam bracket by the outer circumferential surface; and engagement of the engaged section with the lock spring. This leads to a size reduction in the cam, particularly leads to a reduction in an axial dimension (thickness) of the cam.

In the reclining device, the cam preferably has a main body having a plurality of operative parts configured to radially move the lock gears respectively. The shaft part preferably includes a plurality of protrusions axially protruding from the main body. The outer circumferential surface preferably includes radially outer faces of the protrusions. The engaged section is preferably defined, at each of the protrusions, by an end of the protrusion in a circumferential direction of the protrusion.

In the configuration, the shaft part of the cam including the protrusions can have a lighter weight than the weight of a cylindrical shaft. Besides, the radially outer faces of the protrusions constitute the outer circumferential surface of the shaft part. The configuration achieves stabilization of the rotation of the cam and avoids deviation of locking timing between or among the lock gears by the contact of the protrusions of the cam with the inner circumferential surface defining the center hole of the guide bracket.

Further, the engaged section of the shaft part is defined, at each of the protrusions, by an end of the protrusion in the circumferential direction of the protrusion. This configuration facilitates a work of engaging the lock spring with the cam only by engaging the lock spring with the circumferential end of any of the protrusions.

In the reclining device, each of the radially outer faces of the protrusions preferably curves in an arc in an axial view of the cam.

In this configuration, each of the radially outer faces of the protrusions curves in an arc in the axial view of the cam. Thus, the outer circumferential surface of the shaft part including the radially outer faces of the protrusions has a substantially circular shape. This increases a meeting area of the outer circumferential surface of the shaft part and the center hole of the guide bracket, and hence further stabilizes the rotation of the cam. Such stabilization allows the lock gears and the internal gear to stably mesh. Consequently, the stable meshing state can be reliably maintained.

In the reclining device, preferably, a plurality of the lock springs are equally spaced around the center hole in a circumferential direction of the center hole.

In this configuration, the cam receives rotational urging forces applied from the lock springs to the cam and distributed in the circumferential direction. This results in avoiding eccentricity or deviation of the cam from the center.

In the configuration, the lock springs apply their respective rotational urging forces to the cam. Hence, a much smaller spring (i.e., a spring that exerts a small urging force) is adoptable for each of the lock springs. The configuration enables manual assembling of the cam without a large load at the assembling of the lock spring, and hence eliminates the need for preparation of a special device to wind the lock spring.

In the reclining device, preferably, each of the lock springs is preferably a spiral spring.

In this configuration, each of the lock springs is a spiral spring. This configuration achieves a size reduction in an arrangement space for the lock springs, and thus facilitates the arrangement of the lock springs between the guide bracket and the internal gear. The configuration accordingly increases a degree of freedom in design.

In the reclining device, preferably, the guide bracket has a facing surface that faces the internal gear, the facing surface being formed with a plurality of accommodation parts each having a recess section that recesses in a direction away from the internal gear around the center hole, the recess section accommodating associated one of the lock springs therein.

This configuration stabilizes the act of each lock spring being a spiral spring by accommodating the lock spring in the associated recess section of the accommodation part of the guide bracket. The configuration further reduces a protruding amount of the lock spring protruding from the inner surface of the guide bracket, resulting in achievement of a thinner reclining device.

The configuration in which the lock spring is accommodated in the recess section of the accommodation part facilitates the assembling work only by firstly putting the lock spring in the recess section, and thereafter, arranging the cam thereon, and inserting a tool or other member in the center hole of the cam and rotating the tool.

A seat according to the present invention includes: a seat cushion; a seatback located in the rear of the seat cushion and being tiltable in a front-rear direction of the seat; and the reclining device to fixedly hold the seatback at a certain tilt angle.

The seat having this configuration prevents deviation of locking timings between or among the lock gears in the reclining device and achieves a size reduction in the cam. The configuration thus enables stable holding of the seatback and achieves a size reduction in the reclining device.

### EFFECTS OF THE INVENTION

A reclining device and a seat according to the present invention prevent timing deviation between or among a plurality of lock gears, and further achieves a size reduction in a cam.

### BRIEF DESCRIPTION OF DRAWINGS

FIG. 1 is a perspective view illustrating an overall configuration of a seat including a reclining device according to an embodiment of the present invention.

FIG. 2 is a perspective view illustrating a disassembled state of a connecting rod and a reclining mechanism in FIG. 1.

FIG. 3 is an exploded perspective view of the reclining mechanism in FIG. 2.

FIG. 4 is a perspective view of a cam in FIG. 3.

FIG. 5 is an illustration of a guide bracket in FIG. 3 seen from an outer surface of the guide bracket.

FIG. 6 illustrates a state of two lock springs and the cam attached to an inner surface of the guide bracket in FIG. 3.

FIG. 7 includes illustrations of a completed state of the reclining mechanism including an internal gear, a plurality of lock gears, the cam, the guide bracket, and an attachment ring in combination, each component being illustrated in FIG. 3: FIG. 7A is an illustration of the attachment ring seen from an axially outside; FIG. 7B is a cross-sectional view taken along the line A-A in FIG. 7A.

FIG. 8 illustrates rotational urging forces that the cam in FIG. 6 receives from the two lock springs.

FIG. 9 illustrates an operation of engaging two protrusions of the cam in FIG. 6 respectively with outer ends of the two lock springs.

FIG. 10 is an illustration of a state where the outer ends of the two lock springs engage with engaged ends of the protrusions of the cam as seen from the outer surface of the guide bracket.

FIG. 11 is an exploded perspective view of a conventional reclining mechanism.

FIG. 12 is a perspective view of a cam in FIG. 11 seen from an internal gear.

FIG. 13 includes illustrations of a completed state of the conventional reclining mechanism in FIG. 11: FIG. 13A is an illustration of an attachment ring seen from an axially outside; FIG. 13B is a cross-sectional view taken along the line B-B in FIG. 13A.

FIG. 14 illustrates a rotational urging force that the cam in FIG. 11 receives from a single

FIG. 15 illustrates an operation of engaging an outer end of the lock spring in FIG. 11 with an engagement groove of a cam bracket.

### DESCRIPTION OF EMBODIMENTS

Hereinafter, a preferable embodiment of the present invention will be described with reference to the accompanying drawings.

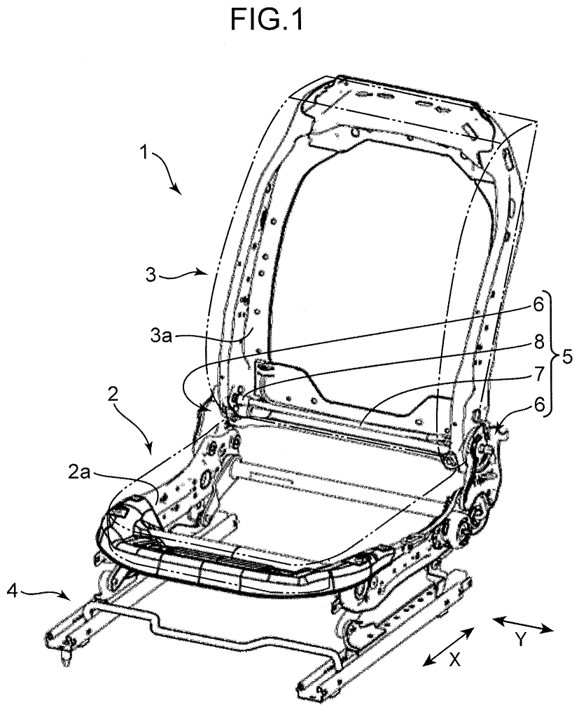

As illustrated in FIG. 1, a seat 1 according to the embodiment is, for example, a vehicle seat, and includes: a seat cushion 2 for supporting buttocks of an occupant; a seatback 3 located in the rear of the seat cushion 2 to support the back of the occupant and being tiltable to the seat cushion 2 in a front-rear direction X of the seat 1; a sliding device 4 attached to a lower portion of the seat cushion 2; and a reclining device 5.

The sliding device 4 is configured to guide the seat cushion 2 slidably in the front-rear direction X of the seat 1, and fixedly hold the seat cushion 2 at a certain position. Here, the seat according to the present invention may not indispensably include the sliding device 4.

The reclining device 5 includes, as a main structure, a reclining mechanism 6 configured to fixedly hold the seatback 3 at a certain tilt angle.

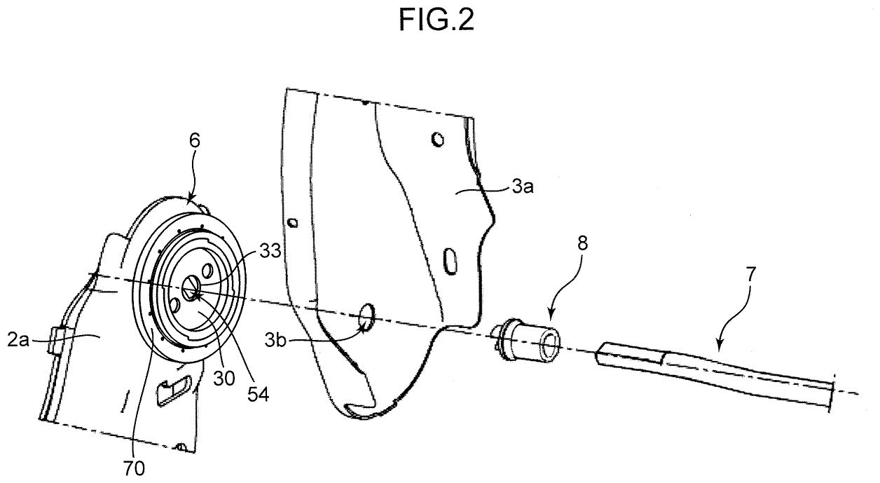

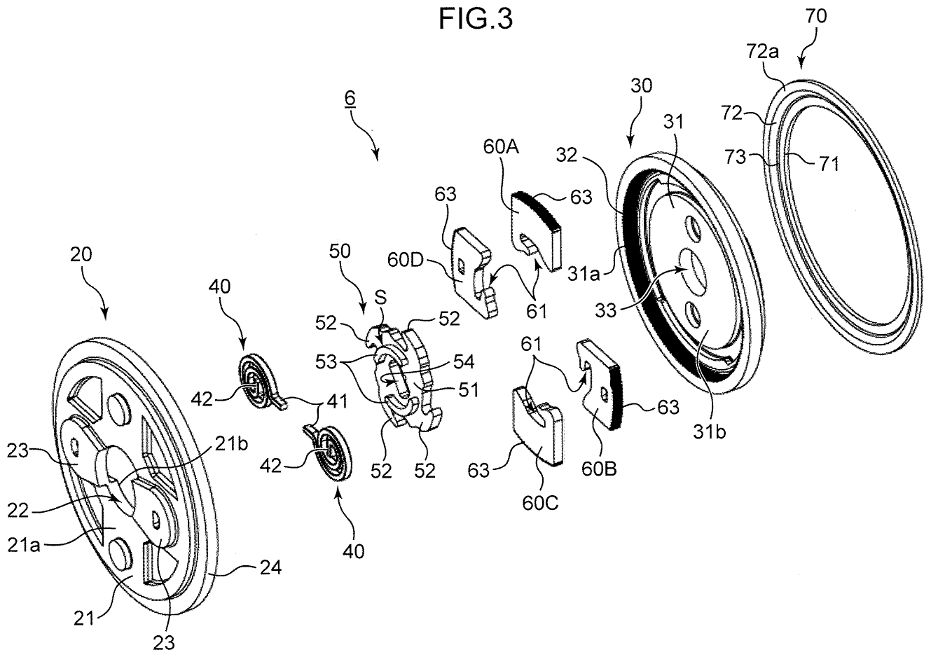

Specifically, as illustrated in FIG. 2 to FIG. 3, the reclining device 5 according to the embodiment includes: a pair of reclining mechanisms 6; a connecting rod 7 connected to each of the reclining mechanisms 6; and a pair of resin bushes 8 to each receive corresponding one of opposite ends of the connecting rod 7. The resin bushes 8 may be excluded.

The two reclining mechanisms 6 are arranged respectively on both sides of the seat 1 in a width direction Y thereof. Each of the reclining mechanisms 6 serves as a clutch to fixedly hold the seatback 3 at a certain tilt angle.

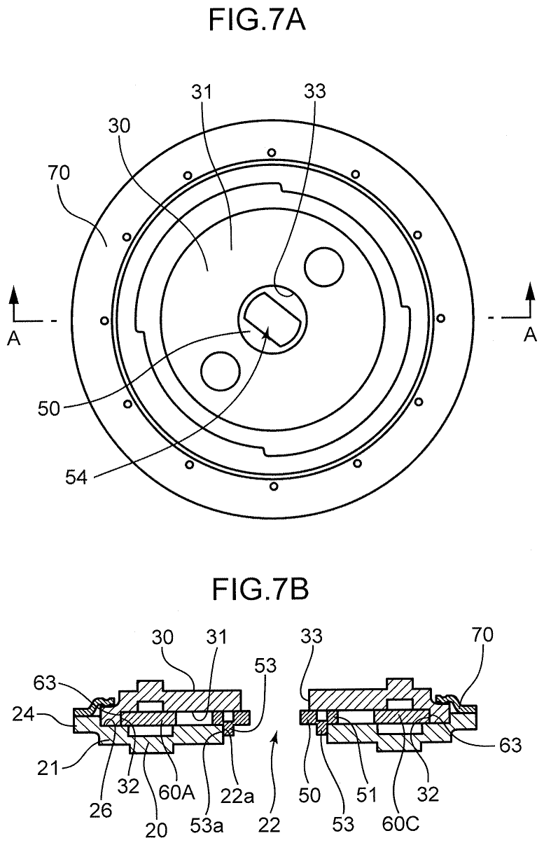

As illustrated in FIG. 3, FIG. 7A, and FIG. 7B, each reclining mechanism 6 includes: a guide bracket 20 having a disc shape; an internal gear 30 facing the guide bracket 20 and having internal teeth 32; a plurality of lock gears 60A to 60D (four lock gears in the embodiment) each having an external tooth 63 configured to mesh with corresponding one of the internal teeth 32; a cam 50 that is configured to move each of the lock gears 60A to 60D in a radial direction of the guide bracket 20; at least one lock spring 40 (two lock springs in the embodiment) that urges the cam 50 rotatably; and an attachment ring 70 that attaches the internal gear 30 to the guide bracket 20. The four lock gears 60A to 60D, the cam 50, and the two lock springs 40 are located between the guide bracket 20 and the internal gear 30. In the embodiment, a small spiral spring is adopted for each of the lock springs 40.

The guide bracket 20 is a plate member having a center hole 22 in a circular shape at the center thereof. The guide bracket 20 in the embodiment is configured to be fixedly attached to a portion around the rear of a frame 2a (specifically, a side frame, see FIG. 1 to FIG. 2) of the seat cushion 2 serving as one of a frame of the seat cushion 2 and a frame of the seatback 3.

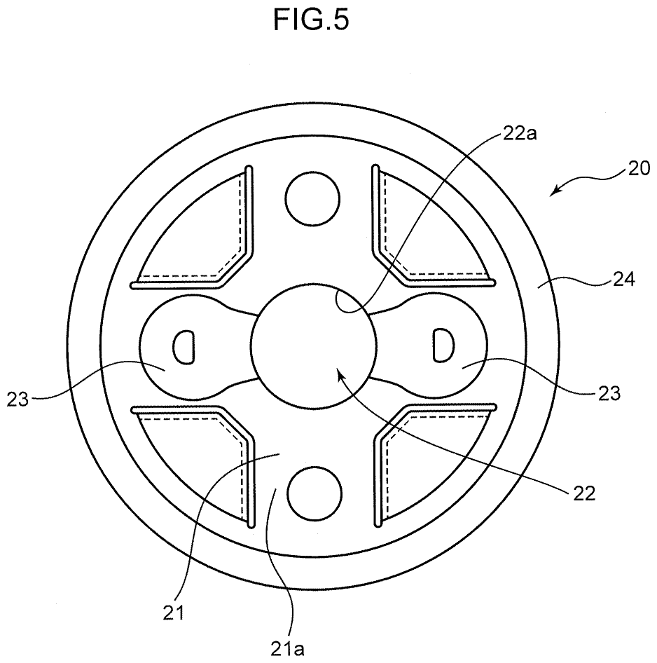

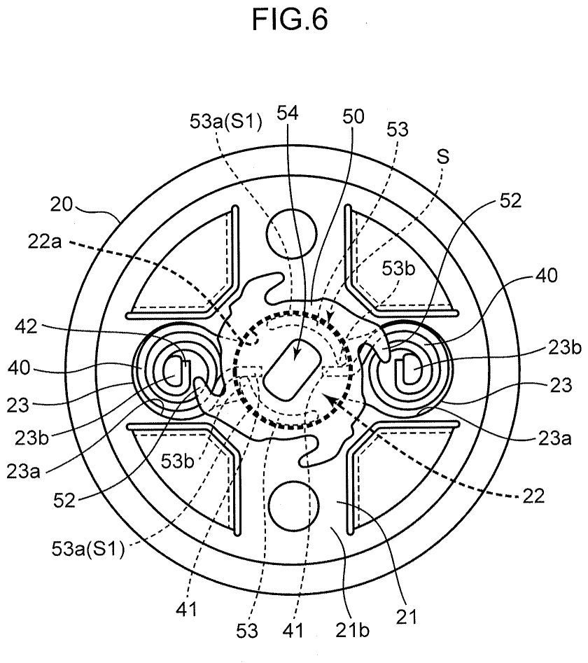

Specifically, as illustrated in FIG. 3, FIG. 5 to FIG. 6, and FIG. 7B, the guide bracket 20 has: a main body 21 having a disc shape and having the center hole 22 in the circular shape at the center thereof; two accommodation parts 23 respectively accommodating the lock springs 40; and a flange 24 extending along an outer circumference of the main body 21.

Each of the two accommodation parts 23 has a recess section 23a (i.e., a semi-penetrating section) that recesses in a direction away from the internal gear 30 around the center hole 22 on an inner surface 21b of the main body 21 serving as a facing surface of the guide bracket 20 that faces the internal gear 30, specifically, recesses toward an outer surface 21a of the main body in an axial direction of the internal gear 30. The recess section 23a opens toward the inner surface 21b of the main body 21 and communicates with the center hole 22, and thus allows an outer end 41 of the lock spring 40 to protrude into the center hole 22 with a swirl portion of the lock spring accommodated in the recess section 23a.

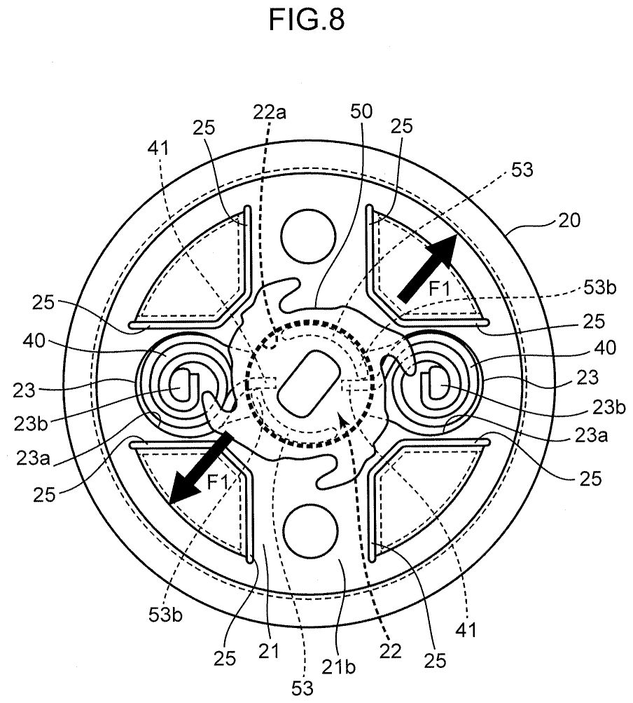

As illustrated in FIG. 8, the guide bracket 20 further includes a plurality of guide walls 25 (guide parts) to guide the four lock gears 60A to 60D respectively in the radial directions of the guide bracket 20 on the inner surface 21b (the facing surface) of the main body 21. The guide walls 25 are arranged at equal intervals in a circumferential direction around the center hole 22 and extend in the radial directions of the guide bracket 20 respectively. Specifically, the guide walls 25 are in pairs and radially extend in four directions from the center hole 22 serving as the center. Consequently, four pairs of guide walls 25 respectively guide the lock gears 60A to 60D in the radial directions of the guide bracket 20.

The internal gear 30 is configured to be fixedly attached to a frame 3a (specifically, a side frame, see FIG. 1 to FIG. 2) of the seatback 3 serving as the other of the frame of the seat cushion 2 and the frame of the seatback 3, while facing the guide bracket 20.

As illustrated in FIG. 3, FIG. 7A, and FIG. 7B, the internal gear 30 includes a recess 31 having a circular shape in an axial view of the internal gear 30 and a substantially recessed shape in cross-section. The recess 31 has an inner circumferential surface 31a formed with the internal teeth 32 over the entire circumference of the inner circumferential surface 31a. The internal teeth 32 protrude from the inner circumferential surface 31a toward the rotation center of the internal gear 30. The internal gear 30 is arranged in such a manner that a bottom surface 31b defining the recess 31 faces the inner surface 21b (facing surface) of the main body 21 of the guide bracket 20. The recess 31 has a through hole 33 at the center thereof. As illustrated in FIG. 2, the through hole 33 is aligned with the through hole 3b of the frame 3a of the seatback 3. The end of the connecting rod 7 and the end of the associated resin bush 8 are inserted in the reclining mechanism 6 through the through hole 33.

As illustrated in FIG. 3 and FIG. 7B, a peripheral edge portion defining the recess 31 is fitted to a bulge 26 of the guide bracket 20, that is, fitted to the bulge 26 defined between the main body 21 and the flange 24 as illustrated in FIG. 7B, in a state where the guide bracket 20 and the recess 31 of the internal gear 30 face each other. This determines a radial position of the internal gear 30 relative to the guide bracket 20.

Besides, the attachment ring 70 is fixedly attached to the flange 24 by welding or other way to prevent the internal gear 30 from coming off in the axial direction. In this manner, the internal gear 30 is connected to the guide bracket 20 rotatably relative thereto.

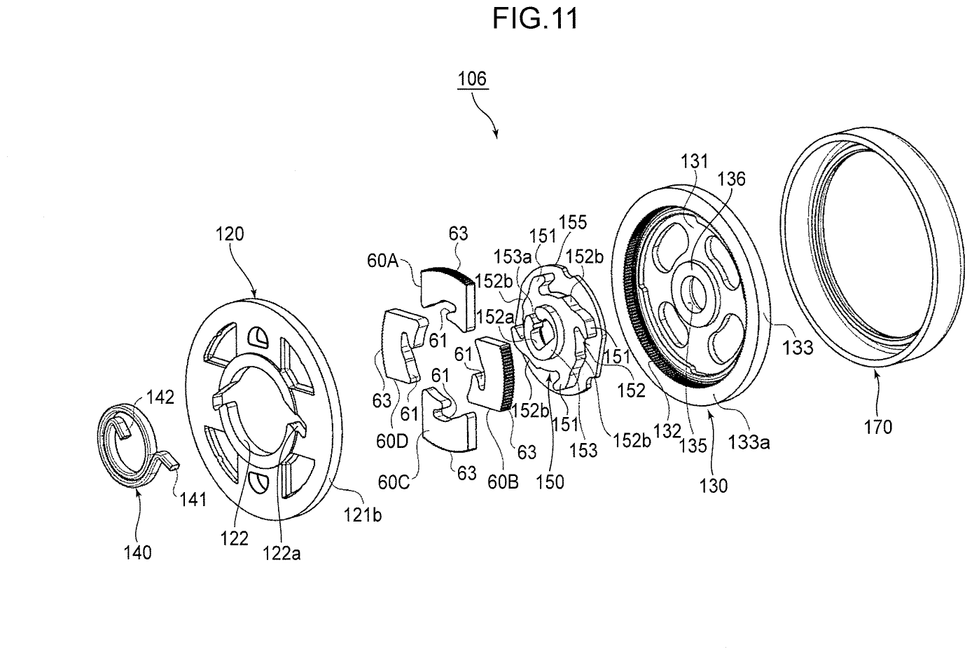

As illustrated in FIG. 3, the four lock gears 60A to 60D are members (i.e., lock plates) each including the external tooth 63 configured to mesh with the associated internal tooth 32 of the internal gear 30, and having a substantially rectangular shape in a plan view. Each lock gear basically has a configuration similar to a configuration of a conventional lock gear (each of the lock gears 60A to 60D in FIG. 11). The lock gears 60A to 60D are arranged to be movable along the inner surface 21b of the guide bracket 20 while being guided by the guide walls 25 at the inner surface 21b in the radial directions of the guide bracket 20. This enables each of the lock gears 60A to 60D to shift between a meshing position where the external tooth 63 and the internal tooth 32 mesh and a release position to release the meshing. Each of the lock gears 60A to 60D has a groove to be engaged 61 cut out in a substantially arc at an inner circumferential surface of the lock gear. The groove to be engaged 61 is a groove to be engaged with an engaging protrusion 52 of the cam 50 to be described later.

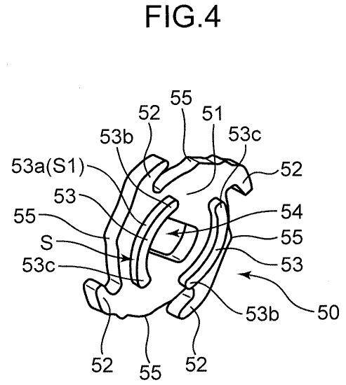

The cam 50 is rotatable relative to the guide bracket 20. As illustrated in FIG. 3 to FIG. 4, FIG. 6, and FIG. 7B, the cam 50 has a main body 51, and a shaft part S protruding from the main body 51 toward the guide bracket 20 in the axial direction of the cam 50 and located in the center hole 22 of the guide bracket 20.

The main body 51 has four engaging protrusions 52 respectively serving as operative parts to radially move the lock gears 60A to 60D and each configured to shift corresponding one of the lock gears 60A to 60D between the meshing position and the release position in response to rotation of the cam 50. Each of the four engaging protrusions 52 extends in a direction of the associated groove to be engaged 61 (see FIG. 3) of corresponding one of the four lock gears 60A to 60D to engage with the groove. Specifically, the engaging protrusions extend in substantially arcs at equal intervals in the circumferential direction to define a quadrangular shape. The engaging protrusions 52 respectively engage with the groove to be engaged 61 of the lock gears 60A to 60D in response to the rotation of the cam 50 to thereby pull the lock gears 60A to 60D radially inward and shift each lock gear from the meshing position to the release position. The main body 51 of the cam 50 has, in addition to the engaging protrusions 52, four bulges 55 (see FIG. 4) each bulging with an outer diameter increasing at a position away from a base of the associated engaging protrusion 52 at a predetermined angle.

The main body 51 has a rod engagement hole 54 at the center thereof. The rod engagement hole 54 receives an end of the connecting rod 7 to engage therewith through the through hole 33 of the internal gear 30. The connecting rod 7 is manually rotated to allow the cam 50 in the reclining mechanism 6 to rotate.

As illustrated in FIG. 4 and FIG. 6, the shaft part S has an outer circumferential surface S1 being in contact with an inner circumferential surface 22a defining the center hole 22 of the guide bracket 20, and an engaged section (an engaged end 53b to be described later) for engagement with the outer end 41 of the lock spring 40.

In the embodiment, the shaft part S includes a plurality of protrusions 53 (two protrusions in the embodiment) protruding from the main body 51 in the axial direction of the cam 50. The outer circumferential surface S1 includes radially outer faces 53a of the two protrusions 53 in a radial view of the cam 50. Each of the radially outer faces 53a curves in an arc in an axial view of the cam 50. Each protrusion 53 is preferably formed to be hollow (i.e., a semi-penetrating shape) when the cam 50 is molded.

In the embodiment, the engaged section is defined, at each of the two protrusions 53, by the engaged end 53b being one end of the protrusion in the circumferential direction of the cam 50. The engaged end 53b is one of the opposite ends 53b and 53c of the protrusion 53 in the circumferential direction thereof, that is, an end facing in a rotation direction (clockwise direction in FIG. 4) in which the engaging protrusion 52 engages with the groove to be engaged 61 of corresponding one of the lock gears 60A to 60D in the circumferential direction of the cam 50.

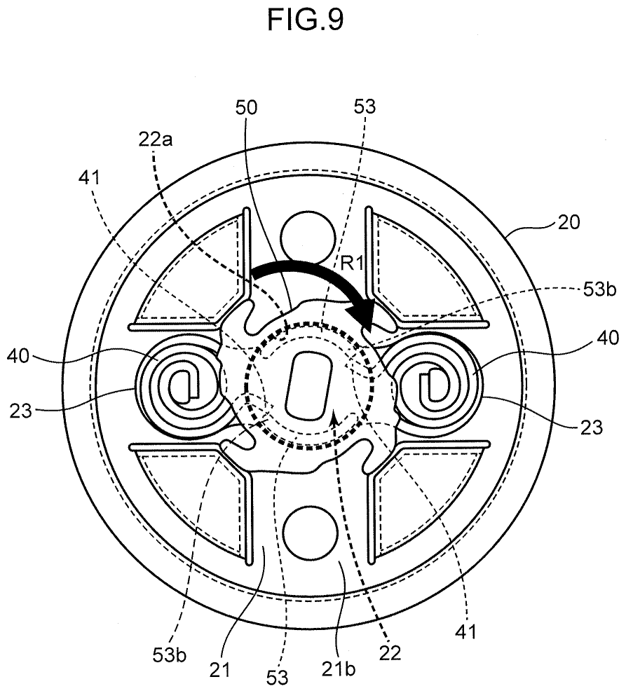

As illustrated in FIG. 6 and FIG. 8 to FIG. 10, the lock spring 40 rotates and urges the cam 50 in a predetermined direction that is opposite to an attachment direction R1 for attachment of the cam 50 illustrated in FIG. 9 by engagement of the outer end 41 of the lock spring 40 with the engaged end 53b of the protrusion 53. Specifically, each lock spring 40 rotates and urges the cam 50 so that the engaging protrusions 52 and the bulges 55 push the lock gears 60A to 60D radially outward from the cam 50 in such a direction as to move each lock gear toward the meshing position where the external tooth 63 meshes with the internal tooth 32 of the internal gear 30.

The cam 50 is rotatably supported relative to the guide bracket 20 by the contact of the outer circumferential surface S1 of the shaft part S with the inner circumferential surface 22a defining the center hole 22 of the guide bracket 20.

As described above, the radial position of the cam 50 relative to the guide bracket 20 is determined by the contact of the inner circumferential surface 22a defining the center hole 22 of the guide bracket 20 with the radially outer faces 53a (i.e., the outer circumferential surface S1 of the shaft part S) of the protrusions 53.

As illustrated in FIG. 3, FIG. 6, and FIG. 8 to FIG. 10, the two lock springs 40 are respectively accommodated in the recess sections 23a of the accommodation parts 23 at the inner surface 21b of the main body 21 of the guide bracket 20 to be equally spaced around the center hole 22 in the circumferential direction, that is, the lock springs 40 are arranged at the opposite positions across the center hole 22 in the embodiment.

Each of the lock springs 40 in the embodiment is a spiral spring resulting from spirally winding a strip-shaped thin metal plate, and has the outer end 41 and an inner end 42. The inner end 42 engages with an engagement protrusion 23b located in the associated recess section 23a of the accommodation part 23 of the guide bracket 20.

The outer end 41 engages with the engaged end 53b of the protrusion 53 of the cam 50. Such engagement allows each of the two lock springs 40 to urge the cam 50 rotatably in such a direction as to shift each of the lock gears 60A to 60D from the release position to the meshing position.

In a normal state in the reclining mechanism 6, the lock gears 60A to 60D are urged radially outward in response to rotation of the cam 50 in one direction (rotation in a direction opposite to the attachment direction R1 for the attachment of the cam 50 illustrated in FIG. 9) based on the elasticity of each lock spring 40 being a spiral spring. By contrast, when the connecting rod 7 receives a rotational manipulation force, the cam 50 rotates in the opposite direction (rotates in the direction R1 in FIG. 9) against the elastic force of each lock spring 40 to shift the lock gears 60A to 60D toward the center. Specifically, when the cam 50 illustrated in FIG. 6 rotates clockwise, the four engaging protrusions 52 of the cam 50 respectively engage with the grooves to be engaged 61 (see FIG. 3) of the lock gears 60A to 60D to pull the lock gears 60A to 60D toward the center. By contrast, when the cam 50 is urged by the lock spring 40 and rotates counterclockwise, the engaging protrusions 52 and the bulges 55 of the cam 50 push the lock gears 60A to 60D radially outward from the cam 50. Each of the lock gears 60A to 60D has an outer circumferential surface formed with the external tooth 63 to mesh with the associated internal tooth 32 of the internal gear 30 when being pushed radially outward, and lock the guide bracket 20 and the internal gear 30 so as not to rotate relative to each other. This configuration achieves holding of the seatback 3 at a certain tilt angle.

### Characteristics of the Embodiment

(1) The reclining mechanism 6 serving as a main structure of the reclining device 5 according to the embodiment includes: the guide bracket 20 having the center hole 22 in a circular shape and the guide walls 25; the internal gear 30; the lock gears 60A to 60D each having an external tooth 63 configured to mesh with an internal tooth 32 of the internal gear 30 and being movable in a radial direction of the guide bracket 20 while being guided by the associated guide wall 25 of the guide bracket 20; the cam 50 that is rotatable relative to the guide bracket 20, the cam 50 being configured to rotate to radially move each of the lock gears 60A to 60D between a meshing position and a release position; and at least one lock spring 40 (two lock springs in the embodiment) that urges the cam 50 rotatably in such a direction as to shift each of the lock gears 60A to 60D from the release position to the meshing position.

The cam 50 has the shaft part S protruding from the main body 51 toward the guide bracket 20 in the axial direction of the cam 50 and located in the center hole 22 in the guide bracket 20.

The shaft part S has the outer circumferential surface S1 being in contact with the inner circumferential surface 22a defining the center hole 22 of the guide bracket 20, and the engaged end 53b being an engaged section for engagement with the lock spring 40.

The cam 50 is rotatably supported relative to the guide bracket 20 by the contact of the outer circumferential surface S1 of the shaft part S with the inner circumferential surface 22a defining the center hole 22 of the guide bracket 20. The cam 50 is further rotatably urged by the lock spring 40 being engaged with the engaged end 53b.

The guide bracket 20 guides the lock gears 60A to 60D radially by the guide walls 25 along the guide bracket 20, specifically, along the inner surface 21b (facing surface) of the main body 21 that faces the internal gear 30, and axially aligns the inner circumferential surface 22a defining the center hole 22 and the shaft part S of the cam 50. In other words, the position of the cam 50 and the position of each of the lock gears 60A to 60D can be determined on the basis of the guide bracket 20 as a reference. This configuration achieves the same locking timing among the lock gears 60A to 60D to be operated by the cam 50 without axial displacement between the guide bracket 20 and the cam 50 regardless of possible manufacturing tolerance in the components including the guide bracket 20 and the cam 50.

Specifically, in the embodiment, the outer circumferential surface S1 (the radially outer faces 53a) of the shaft part S (the protrusions 53 in the embodiment) of the cam 50 is in contact with the inner circumferential surface 22a defining the center hole 22 of the guide bracket 20. The embodiment thus stabilizes the rotation of the cam 50, and avoids deviation of locking timing among the lock gears 60A to 60D.

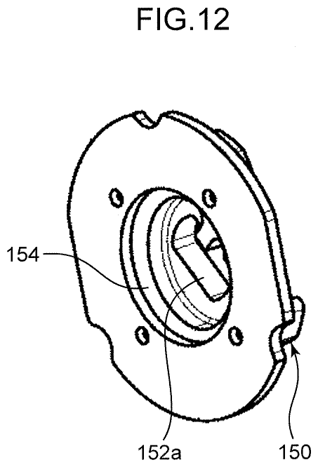

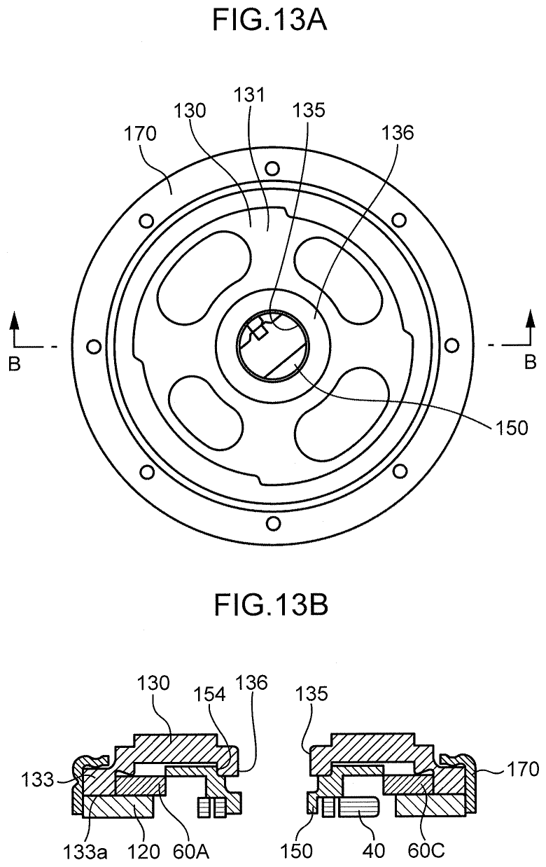

Here, the conventional reclining mechanism 106 illustrated in FIG. 11 to FIG. 13 is referred to as a comparison example. As described above, concerning determination of the radial position of the conventional cam 150, the position of the cam 150 is determined on the basis of the outer circumferential surface of the second shaft portion 136 of the internal gear 130 as a reference through the fitting of the second shaft portion 136 in the recess 154 of the cam 150. By contrast, the radial position of the cam between the internal gear 30 and the guide bracket 20 is determined by the attachment ring 70.

Specifically, the conventional reclining mechanism 106 prevents axial displacement of the cam 150 relative to the lock gears 60A to 60D, whose positions are restricted at the guide bracket 120, by making the recess 154 of the cam 150 receive the second shaft portion 136 of the internal gear 130 fitting therein. Unfortunately, when the components including the guide bracket 20, the internal gear 30, and the cam 150 shift from one another due to manufacturing tolerance or other factor, the relative positional relation between the lock gears 60A to 60D and the cam 50 may change. The locking timing among the lock gears 60A to 60D may eventually differ from one another.

In comparison with the conventional mechanism, the reclining mechanism 6 in the embodiment has such a structure that the outer circumferential surface S1 (the radially outer faces 53a) of the shaft part S (the protrusions 53) of the cam 50 is in contact with the inner circumferential surface defining the center hole 22 of the guide bracket 20 and that the cam 50 is rotatably supported relative to the guide bracket 20. The structure enables determination of the position of the cam 50 and the position of each of the lock gears 60A to 60D on the basis of the guide bracket 20 as a reference. It is seen from this perspective that the reclining mechanism 6 in the embodiment is less likely to be affected by such manufacturing tolerance in the components, and thus achieves the same locking timing among the lock gears 60A to 60D to be operated by the cam 50.
(2) The shaft part S of the cam 50 fulfills the following two functions: axial alignment with the guide bracket 20 by the outer circumferential surface S1; and engagement of the engaged end 53b being the engaged section with the lock spring 40. This leads to a size reduction in the cam 50, particularly leads to a reduction in an axial dimension (thickness) of the cam 50.

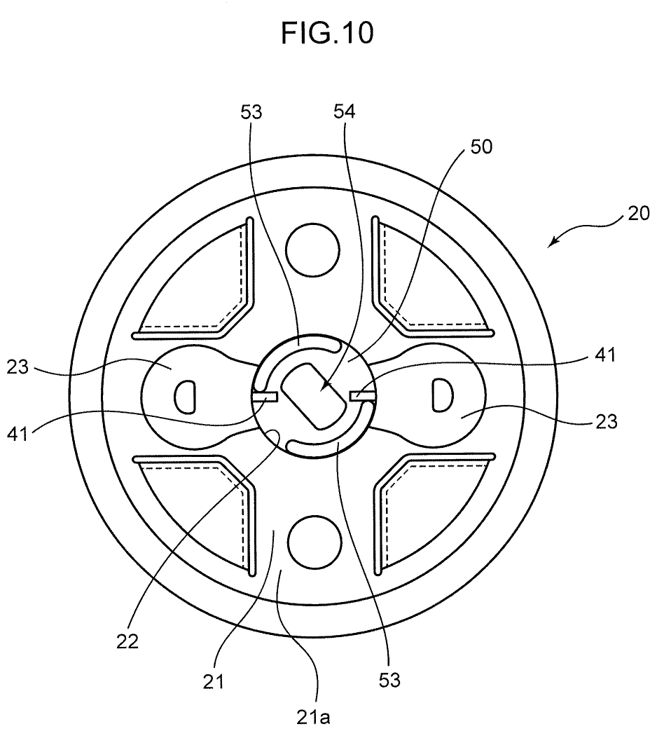

Moreover, the embodiment makes the protrusion 53 of the cam 50 for prevention of the axial displacement be engaged with the outer end 41 of the lock spring 40, and hence eliminates the need to provide another component or structure for engagement with the outer end 41 of the lock spring 40.
(3) As illustrated in FIG. 10, in the structure in the embodiment, the outer end 41 of the lock spring 40 extends to the inside of the center hole 22 of the guide bracket 20 and engages with the engaged end 53b being an engaged section of the shaft part S of the cam 50. In this structure, the outer end 41 of the lock spring 40 engaging with the engaged end 53b being the engaged section of the shaft part S (protrusions 53) of the cam 50 is visible from the outside of the reclining mechanism 6 through the center hole 22 of the guide bracket 20 in the view from the outer surface 21a of the main body 21 of the guide bracket 20. The structure thus enables visual confirmation concerning appropriate or inappropriate engagement of the lock spring 40 with the cam 50 after the assembling of the reclining mechanism 6, and improves assembling performance.
(4) In the reclining device according to the embodiment, the shaft part S of the cam 50 includes the protrusions 53 axially protruding from the main body 51 of the cam 50. The outer circumferential surface S1 includes the radially outer faces 53a of the protrusions 53. The engaged section of the cam 50 for engagement with the outer end 41 of the lock spring 40 is defined, at each of the protrusions 53, by the associated engaged end 53b being an end of the protrusion 53 in the circumferential direction of the protrusion, i.e., in the circumferential direction agreeing with the circumferential direction of the cam 50.

The shaft part S of the cam 50 including the protrusions 53 in this manner can have a lighter weight than the weight of a cylindrical shaft. Besides, the radially outer faces 53a of the protrusions 53 constitute the outer circumferential surface S1 of the shaft part S. The configuration achieves stabilization of the rotation of the cam 50 and avoids deviation of locking timing among the lock gears 60A to 60D by the contact of the protrusions 53 of the cam 50 with the inner circumferential surface 22a defining the center hole 22 of the guide bracket 20.

Further, the engaged section of the shaft part S is defined, at each of the protrusions 53, by the engaged end 53b being an end of the protrusion 53 in the circumferential direction of the protrusion. This configuration facilitates a work of engaging the lock spring 40 with the cam 50 only by engaging the lock spring 40 with the engaged end 53b being a circumferential end of any of the protrusions 53.
(5) The above-described structure is a simple structure that brings each protrusion 53 of the cam 50 into sliding contact with the inner circumferential surface 22a defining the center hole 22 of the guide bracket 20 without the need to provide another bulge or other section to bring the protrusion 53 into sliding contact with a portion around the center hole 22 of the guide bracket 20. The structure thus achieves good processability of the guide bracket 20 and improves dimensional accuracy. The structure further eliminates the need to increase the radially outward size of the guide bracket 20 to form such a bulge, and thus achieves a size reduction in the guide bracket 20.
(6) In the reclining mechanism 6 in the embodiment, each of the radially outer faces 53a of the protrusions 53 curves in an arc in the axial view of the cam 50. Thus, the outer circumferential surface S1 of the shaft part S including the radially outer faces 53a of the protrusions 53 has a substantially circular shape. This increases a meeting area of the outer circumferential surface S1 of the shaft part S and the center hole 22 of the guide bracket 20, and hence further stabilizes the rotation of the cam 50. Such stabilization allows the lock gears 60A to 60D and the internal gear 30 to stably mesh. Consequently, the stable meshing state can be reliably maintained.
(7) In the reclining mechanism 6 in the embodiment, a plurality of the lock springs 40 (two lock springs in the embodiment) are equally spaced around the center hole 22 in the circumferential direction on the inner surface 21b of the main body 21 that is a facing surface of the guide bracket 20. In this configuration, the cam 50 receives rotational urging forces applied from the lock springs 40 to the cam 50 and distributed in the circumferential direction. For instance, as illustrated in FIG. 8, two rotational urging forces F1 that the cam 50 receives from the lock springs 40 are distributed in the circumferential direction of the cam 50 and that face in the opposite directions across the rotation center of the cam 50, and thus are radially balanced. This results in avoiding eccentricity or deviation of the cam 50 from the center.

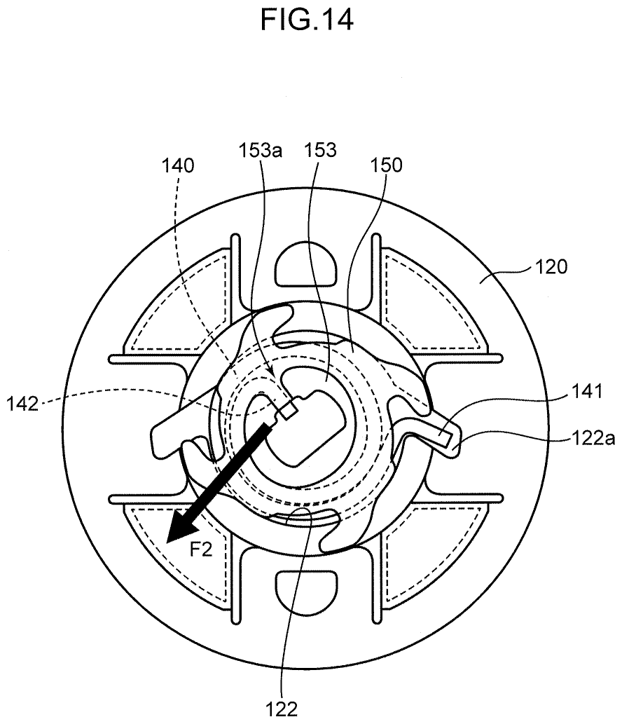

Referring to the conventional reclining mechanism 106 illustrated in FIG. 11 and FIG. 14 as the comparative example, a rotational urging force F2 that the cam 150 receives from the single lock spring 140 becomes an eccentricity force of the cam 150 to make the cam 150 and the internal gear 30 shift from the center relative to the guide bracket 20.

It is seen from these perspectives that the embodiment having the configuration of the lock springs 40 equally spaced in the circumferential direction achieves prevention of the eccentricity of the cam 50.
(8) In the configuration in the embodiment, the (two) lock springs 40 apply their respective rotational urging forces to the cam. Hence, a much smaller spring (i.e., a spring that exerts a small urging force) is adoptable for each of the lock springs 40. The configuration enables manual assembling of the cam 50 without a large load at the assembling of the lock spring 40, and hence eliminates the need for preparation of a special device to wind the lock spring 40.

For instance, as illustrated in FIG. 9, in assembling the cam 50, first, the two lock springs 40 are respectively accommodated in the accommodation parts 23 of the guide bracket 20. Thereafter, the two protrusions 53 of the cam 50 are inserted in the center hole 22 of the guide bracket 20. The cam 50 is manually rotated in the predetermined attachment direction R1 (i.e., in the direction in which the engaging protrusions 52 of the cam 50 respectively engage with the engaged grooves 61 of the lock gears 60A to 60D to shift each of the lock gears 60A to 60D from the meshing position to the release position) to press each engaged end 53b of each protrusion 53 against the outer end 41 of the associated lock spring 40. This consequently enables manual assembling of the cam 50. In the cam 50 having been assembled in this manner, the four engaging protrusions 52 of the cam 50 in FIG. 3 are positioned to be engaged with or disengaged from the associated grooves to be engaged 61 of the lock gears 60A to 60D.

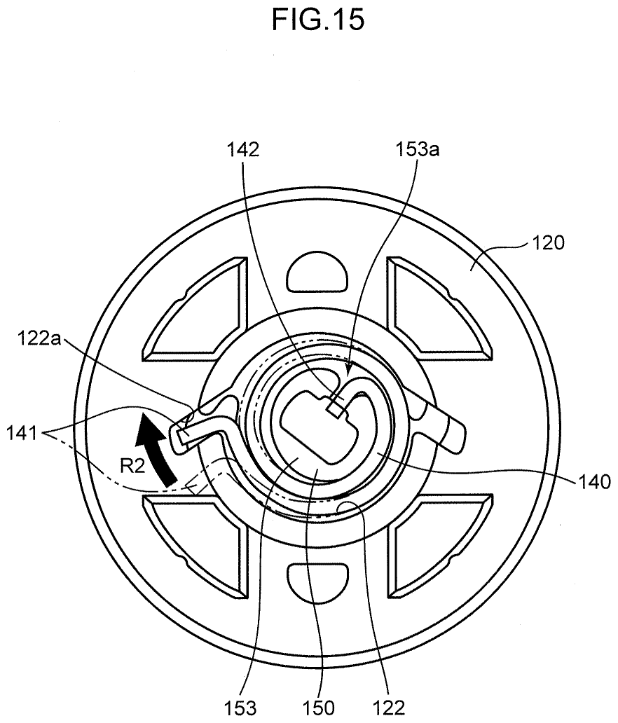

In comparison with the embodiment, for the attachment of the lock spring 140 in the conventional reclining mechanism 106 illustrated in FIG. 11 and FIG. 15 in the comparative example, the inner end 142 of the lock spring 140 engages with the engagement groove 153a of the first shaft portion 153 of the cam 150 and the outer end 141 engages with the engagement groove a of the guide bracket 120 while the cam 150 receives a rotational force to enclose the inner end 142. Accordingly, a special enclosure device to generate a large rotational force against a large reaction force from the lock spring 140 is required at the attachment of the cam 150.

By contrast, in the reclining mechanism 6 in the embodiment, the (two) lock springs 4 and the cam 50 are arranged at the guide bracket 20 illustrated in FIG. 9, and the lock springs 40 are flexed only by manually rotating the cam 50 to store elastic energy, as described above. Further, the reaction forces from the lock springs 40 to the cam 50 are small. This eliminates the need for the aforementioned special enclosure device.
(9) In the reclining mechanism 6 in the embodiment, each of the lock springs 40 is a spiral spring. This configuration achieves a size reduction in an arrangement space for the lock springs 40, and thus facilitates arrangement of the lock springs 40 between the guide bracket 20 and the internal gear 30. The configuration accordingly increases a degree of freedom in design.
(10) In the reclining mechanism 6 in the embodiment, the guide bracket 20 includes the accommodation parts 23 each having the recess section 23a (i.e., the semi-penetrating section) that recesses in a direction away from the internal gear 30 around the center hole 22 on the inner surface 21b of the main body 21 serving as the facing surface that faces the internal gear 30. The recess section 23a accommodates associated one of the lock springs 40 each being the spiral spring.

This configuration stabilizes the act of each lock spring 40 being a spiral spring by accommodating the lock spring 40 in the associated recess section 23a of the accommodation part 23 of the guide bracket 20. The configuration further reduces a protruding amount of the lock spring 40 protruding from the inner surface of the guide bracket 20, resulting in achievement of a thinner reclining device 5.

The configuration in which the lock spring is accommodated in the recess section 23a of the accommodation part 23 facilitates the assembling work only by firstly putting the lock spring 40 in the recess section 23a, and thereafter, arranging the cam 50 thereon, and inserting a tool or other member in the center hole of the cam 50 and rotating the tool.

Here, the embodiment will be described in more detail in comparison with the comparative example. As illustrated in FIG. 15 associated with the comparative example, the conventional reclining mechanism 106 makes the inner end 142 of the lock spring 140 meet the engagement groove 153a (slit) of the cam 150 to engage with the groove. In the engaging state, the outer end 141 is pulled upward to engage with the guide bracket 120. Hence, a reaction force at pulling the outer end 141 upward is large. This necessitates preparation for a special enclosure device, and the assembling work is complicated. By contrast, the configuration in the embodiment enables simple assembling as illustrated in FIG. 9. Specifically, each engaged end 53b of the cam 50 is engageable with the outer end 41 of the associated lock spring 40 only by firstly accommodating the lock spring 40 in the accommodation part, and thereafter, arranging the cam 50 and rotating the cam 50 in the direction denoted by the arrow R2 (preferably, inserting the tool in an opening of the cam 50 at the center thereof and rotating the cam 50). This facilitates the assembling.
(11) As illustrated in FIG. 1, the seat 1 according to the embodiment includes: the seat cushion 2; the seatback 3 located in the rear of the seat cushion 2 and being tiltable in the front-rear direction X of the seat; and the reclining device 5 including the reclining mechanism 6 in the embodiment as a main structure to fixedly hold the seatback 3 at a certain tilt angle.

The seat 1 having this configuration prevents deviation of locking timings among the lock gears 60A to 60D in the reclining mechanism 6 serving as the main structure of the reclining device 5, and achieves a size reduction in the cam 50. The configuration thus enables stable holding of the seatback 3 and achieves a size reduction in the reclining device 5.

### Modifications

(A) Although the two lock springs 40 are equally spaced in the circumferential direction of the guide bracket 20 in the embodiment, the present invention may include at least one lock spring without limitation to the two springs. The reclining mechanism 6 therefore may be configured to include one lock spring, or three or more lock springs.

Various kinds of lock springs such as a plate spring, a coil spring, a rubber spring, and an air spring may be adoptable for the lock spring without limitation to the spiral spring in the embodiment.

(B) Although each protrusion 53 in an arc shape is exemplified in the embodiment, the protrusion 53 may have any shape as long as the protrusion has the radially outer faces 53a constituting the outer circumferential surface S1 of the shaft part S and the engaged section (engaged end 53b) for engagement with the outer end 41 of the lock spring 40. The protrusion 53 may be a small protrusion having a pointed shape or a block shape other than the arc shape. In the case of the protrusion 53 in the form of such a small protrusion, more protrusions 53 may be provided to be engaged with more lock springs 40. This configuration increases a degree of freedom in design for the reclining device.

(C) Although the shaft part S includes the plurality of protrusions 53 (two protrusions) in the example in the embodiment, the present invention is not limited to this example. Some embodiments may adopt any shaft part S having the outer circumferential surface S1 being in contact with the inner circumferential surface 22a defining the center hole 22 of the guide bracket 20 and an engaged section engaged with the lock spring 40. For instance, in a modification of the present invention, the shaft part S may have one protrusion 53 being continuous in the form of a ring, and have a hole or a protrusion on a circumference of the ring that is engageable with the end of the lock spring.

In a structure having a hole, a large force is required to retain a lock spring at a cam. This faces difficulty in attaining the improvement in the assembling performance. Alternatively, in a structure with a protrusion on the outer circumferential surface S1 of the protrusion 53 in the ring shape, the outer end 41 of the lock spring is invisible from the outside through the center hole 22 of the guide bracket 20. From these perspectives, the shaft part S is preferably configured to include the protrusions 53 like the shaft part in the embodiment in terms of the improvement in the assembling performance and visual confirmation concerning the assembling of the lock spring.

(D) Although the center hole 22 of the guide bracket 20 is exemplified as a through hole in the embodiment, the present invention may include a recess having a closed bottom without limitation to the through hole. However, the center hole 22 in the form of the through hole is preferable to enable visual confirmation from the outside of the guide bracket 20 concerning appropriate or inappropriate engagement of the lock spring with the protrusion 53 of the cam 50.

(E) Although the guide bracket 20 is configured to be fixedly attached to the frame 2a of the seat cushion 2 and the internal gear 30 is configured to be fixedly attached to the frame 3a of the seatback 3 in the embodiment, the present invention is not limited to this arrangement. The guide bracket 20 and the internal gear 30 may be arranged the other way round. Specifically, the internal gear 30 may be fixedly attached to the frame 2a of the seat cushion 2, and the guide bracket 20 may be fixedly attached to the frame 3a of the seatback 3.

### Summary of the Embodiment

The embodiment is summarized in the following manner.

A reclining device according to the embodiment includes: a guide bracket that is a plate member having a center hole in a circular shape, the guide bracket being configured to be fixedly attached to one of a frame of a seat cushion and a frame of a seatback; an internal gear configured to be fixedly attached to the other of the frame of the seat cushion and the frame of the seatback in such a manner as to be rotatable relative to the guide bracket; a plurality of lock gears each having an external tooth configured to mesh with an internal tooth of the internal gear, each arranged in such a manner as to be movable along the guide bracket in a radial direction of the guide bracket, and each being shiftable between a meshing position where the external tooth and the internal tooth mesh and a release position where the meshing is released; a cam that is rotatable relative to the guide bracket, and configured to radially move each of the lock gears between the meshing position and the release position; and at least one lock spring that r urges the cam rotatably in such a direction as to shift the lock gear from the release position to the meshing position. The guide bracket has a plurality of guide parts located away from each other in a circumferential direction around the center hole to respectively radially guide the lock gears. The cam has a shaft part located in the center hole of the guide bracket. The shaft part has an outer circumferential surface being in contact with an inner circumferential surface defining the center hole and an engaged section for engagement with the lock spring. The cam is rotatably supported relative to the guide bracket by the contact of the outer circumferential surface of the shaft part with the inner circumferential surface defining the center hole, and is rotatably urged by the lock spring by the engagement of the lock spring with the engaged section.

In the configuration, the cam has the shaft part located in the center hole of the guide bracket. The shaft part has the outer circumferential surface being in contact with the inner circumferential surface defining the center hole of the guide bracket, and the engaged section for engagement with the lock spring. The cam is rotatably supported relative to the guide bracket by the contact of the outer circumferential surface of the shaft part with the inner circumferential surface defining the center hole of the guide bracket.

The guide bracket guides the lock gears radially by the guide walls along the guide bracket, and axially aligns the inner circumferential surface defining the center hole and the shaft part of the cam. In other words, the position of the cam and the position of each of the lock gears can be determined on the basis of the guide bracket as a reference. This configuration achieves the same locking timing between or among the lock gears to be operated by the cam without axial shift between the guide bracket and the cam regardless of possible manufacturing tolerance in the components including the guide bracket and the cam.

The shaft part of the cam fulfills the following two functions: axial alignment with the cam bracket by the outer circumferential surface; and engagement of the engaged section with the lock spring. This leads to a size reduction in the cam, particularly leads to a reduction in an axial dimension (thickness) of the cam.

In the reclining device, the cam preferably has a main body having a plurality of operative parts configured to radially move the lock gears respectively. The shaft part preferably includes a plurality of protrusions axially protruding from the main body. The outer circumferential surface preferably includes radially outer faces of the protrusions. The engaged section is preferably defined, at each of the protrusions, by an end of the protrusion in a circumferential direction of the protrusion.

In the configuration, the shaft part of the cam including the protrusions can have a lighter weight than the weight of a cylindrical shaft. Besides, the radially outer faces of the protrusions constitute the outer circumferential surface of the shaft part. The configuration achieves stabilization of the rotation of the cam and avoids deviation of locking timing between or among the lock gears by the contact of the protrusions of the cam with the inner circumferential surface defining the center hole of the guide bracket.

Further, the engaged section of the shaft part is defined, at each of the protrusions, by an end of the protrusion in the circumferential direction of the protrusion. This configuration facilitates a work of engaging the lock spring with the cam only by engaging the lock spring with the circumferential end of any of the protrusions.

In the reclining device, each of the radially outer faces of the protrusions preferably curves in an arc in an axial view of the cam.

In this configuration, each of the radially outer faces of the protrusions curves in an arc in the axial view of the cam. Thus, the outer circumferential surface of the shaft part including the radially outer faces of the protrusions has a substantially circular shape. This increases a meeting area of the outer circumferential surface of the shaft part and the center hole of the guide bracket, and hence further stabilizes the rotation of the cam. Such stabilization allows the lock gears and the internal gear to stably mesh. Consequently, the stable meshing state can be reliably maintained.

In the reclining device, preferably, a plurality of the lock springs are equally spaced around the center hole in a circumferential direction of the center hole.

In this configuration, the cam receives rotational urging forces applied from the lock springs to the cam and distributed in the circumferential direction. This results in avoiding eccentricity or deviation of the cam from the center.

In the configuration, the lock springs apply their respective rotational urging forces to the cam. Hence, a much smaller spring (i.e., a spring that exerts a small urging force) is adoptable for each of the lock springs. The configuration enables manual assembling of the cam without a large load at the assembling of the lock spring, and hence eliminates the need for preparation of a special device to wind the lock spring.

In the reclining device, preferably, each of the lock springs is a spiral spring.

As each of the lock springs in this configuration is a spiral spring, this configuration achieves a size reduction in an arrangement space for the lock springs, and thus facilitates arrangement of the lock springs between the guide bracket and the internal gear. The configuration accordingly increases a degree of freedom in design.

In the reclining device, preferably, the guide bracket has a facing surface that faces the internal gear, the facing surface being formed with a plurality of accommodation parts each having a recess section that recesses in a direction away from the internal gear around the center hole, the recess section accommodating associated one of the lock springs therein.

This configuration stabilizes the act of each lock spring being a spiral spring by accommodating the lock spring in the associated recess section of the accommodation part of the guide bracket. The configuration further reduces a protruding amount of the lock spring protruding from the inner surface of the guide bracket, resulting in achievement of a thinner reclining device.

The configuration having the lock springs being accommodated in the recess section of the accommodation part facilitates the assembling work only by firstly putting the lock spring in the recess section, and thereafter, arranging the cam thereon, and inserting a tool or other member in the center hole of the cam and rotating the tool.

A seat according to the present invention includes: a seat cushion; a seatback located in the rear of the seat cushion and being tiltable in a front-rear direction of the seat; and the reclining device to fixedly hold the seatback at a certain tilt angle.

The seat having this configuration prevents deviation of locking timings between or among the lock gears in the reclining device and achieves a size reduction in the cam. The configuration thus enables stable holding of the seatback and achieves a size reduction in the reclining device.

A reclining device and a seat according to the embodiment prevent deviation of locking timings between or among a plurality of lock gears, and further achieves a size reduction in a cam.

1. A reclining device, comprising:
a guide bracket that is a plate member having a center hole in a circular shape, the guide bracket being configured to be fixedly attached to one of a frame of a seat cushion and a frame of a seatback;
an internal gear configured to be fixedly attached to the other of the frame of the seat cushion and the frame of the seatback in such a manner as to be rotatable relative to the guide bracket;
a plurality of lock gears each having an external tooth configured to mesh with an internal tooth of the internal gear, each arranged in such a manner as to be movable along the guide bracket in a radial direction of the guide bracket, and each being shiftable between a meshing position where the external tooth and the internal tooth mesh and a release position where the meshing is released;
a cam that is rotatable relative to the guide bracket, and configured to radially move each of the lock gears between the meshing position and the release position; and
at least one lock spring that urges the cam rotatably in such a direction as to shift the lock gear from the release position to the meshing position, wherein
the guide bracket has a plurality of guide parts located away from each other in a circumferential direction around the center hole to respectively radially guide the lock gears,
the cam has a shaft part located in the center hole of the guide bracket,
the shaft part has an outer circumferential surface being in contact with an inner circumferential surface defining the center hole and an engaged section for engagement with the lock spring, and
the cam is rotatably supported relative to the guide bracket by the contact of the outer circumferential surface of the shaft part with the inner circumferential surface defining the center hole, and is rotatably urged by the lock spring by the engagement of the lock spring with the engaged section.

2. The reclining device according to claim 1, wherein the cam has a main body having a plurality of operative parts configured to radially move the lock gears respectively,
the shaft part includes a plurality of protrusions axially protruding from the main body,
the outer circumferential surface includes radially outer faces of the protrusions, and
the engaged section is defined, at each of the protrusions, by an end of the protrusion in a circumferential direction of the protrusion.

3. The reclining device according to claim 2, wherein each of the radially outer faces of the protrusions curves in an arc in an axial view of the cam.

4. The reclining device according to claim 1, wherein a plurality of the lock springs are equally spaced around the center hole in a circumferential direction of the center hole.

5. The reclining device according to claim 4, wherein each of the lock springs is a spiral spring.

6. The reclining device according to claim 5, wherein the guide bracket has a facing surface that faces the internal gear, the facing surface being formed with a plurality of accommodation parts each having a recess section that recesses in a direction away from the internal gear around the center hole, the recess section accommodating associated one of the lock springs therein.

7. A seat, comprising:
a seat cushion;
a seatback located in the rear of the seat cushion and being tiltable in a front-rear direction of the seat; and
the reclining device according to claim 1 to fixedly hold the seatback at a certain tilt angle.
